(19) United States
(12) Patent Application Publication
(10) Pub. No.: US 2020/0044326 A1
(43) Pub. Date: Feb. 6, 2020

(54) COMPOSITE STACK-UP FOR FLAT PANEL METAMATERIAL ANTENNA

(71) Applicant: Kymeta Corporation, Redmond, WA (US)

(72) Inventors: Stephen OLFERT, Kent, WA (US); David LEVESQUE, Redmond, WA (US); Brad LAIRD, Kirkland, WA (US); Steven LINN, Hillsboro, OR (US); Benjamin ASH, Seattle, WA (US); Ryan A. STEVENSON, Woodinville, WA (US); Ken HARP, Kirkland, WA (US); Hamid TORABI, Kirkland, WA (US); Mohsen SAZEGAR, Kirkland, WA (US); Chris EYLANDER, Redmond, WA (US); Mike SLOTA, Kirkland, WA (US); Robert MOREY, Sammamish, WA (US); Andrew TURNER, Seattle, WA (US); Robert Thomas HOWER, Marion, WA (US)

(21) Appl. No.: 16/529,560

(22) Filed: Aug. 1, 2019

Related U.S. Application Data
(60) Provisional application No. 62/714,654, filed on Aug. 3, 2018.

(51) Int. Cl. H01Q 1/36; H01Q 1/38; H01Q 1/40; H01Q 1/08

(52) U.S. Cl. CPC H01Q 1/364; H01Q 1/085; H01Q 1/40; H01Q 1/38

(57) ABSTRACT

A composite stack-up for an antenna is described. In one embodiment, the antenna is a flat panel metamaterial antenna. In one embodiment, an antenna assembly comprises an antenna element layer having an upper side and a lower side; a first set of one or more layers forming an upper stack bonded to the upper side of the antenna element layer and being are at least partially transparent to radio frequency (RF) radiation; and a second set of one or more layers forming a lower stack bonded to the lower side of the antenna element layer, where the antenna element layer, upper stack and lower stack are bonded together to form a composite stack.

### PRIORITY

The present patent application claims priority to and incorporates by reference the corresponding provisional patent applications No. 62/714,654, titled, “COMPOSITE STACK-UP FOR FLAT PANEL METAMATERIAL ANTENNA,” filed on Aug. 3, 2018.

### TECHNICAL FIELD

The disclosed embodiments relate generally to antennas and in particular, but not exclusively, to a flat-panel metamaterial antenna including a composite stack-up.

### BACKGROUND

Stack-ups is a term that has been used in printed circuit board (PCB) manufacturing for a while. Such stack-ups often have an arrangement of metal layers and insulating layers that make up a PCB prior to the board layout. The metal layers are typically copper. The purpose behind the PCB stack-ups is to enable more circuitry to fit on a single circuit board by using multiple PCB board layers. Because the stack-ups have such a specific purpose in PCB manufacturing, they have not found uses in the manufacturing of other types of products, such as the manufacture of satellite antennas.

### SUMMARY

A composite stack-up for an antenna is described. In one embodiment, the antenna is a flat panel metamaterial antenna. In one embodiment, an antenna assembly comprises an antenna element layer having an upper side and a lower side; a first set of one or more layers forming an upper stack bonded to the upper side of the antenna element layer and being are at least partially transparent to radio frequency (RF) radiation; and a second set of one or more layers forming a lower stack bonded to the lower side of the antenna element layer, where the antenna element layer, upper stack and lower stack are bonded together to form a composite stack.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1A-1B are a plan view and a cross-section, respectively of an embodiment of a flat-panel metamaterial antenna. The cross-section of FIG. 1B is taken substantially along section line B-B in FIG. 1A.

FIGS. 2A-2B are cross-sections of an embodiment of a flat-panel metamaterial antenna. FIG. 2A is an exploded view, FIG. 2B is an assembled view.

FIGS. 3A-3C are plan views of embodiments of an antenna element layer in a flat-panel metamaterial antenna.

FIG. 4 is an exploded cross-section of an embodiment of an upper stack of a flat-panel metamaterial antenna.

FIGS. 5A-5B are cross-sections of an embodiment of a lower stack of a flat-panel metamaterial antenna. FIG. 5A is an exploded view; FIG. 5B is an assembled view.

FIGS. 6A-6B are cross-sections of an embodiment of a lower stack of a flat-panel metamaterial antenna. FIG. 6A is an exploded view, and FIG. 6B is an assembled view.

FIG. 7A illustrates the schematic of one embodiment of a cylindrically fed holographic radial aperture antenna.

FIG. 7B illustrates a perspective view of one row of antenna elements that includes a ground plane and a reconfigurable resonator layer.

FIG. 8A illustrates one embodiment of a tunable resonator/slot.

FIG. 8B illustrates a cross section view of one embodiment of a physical antenna aperture.

FIGS. 9A-D illustrate one embodiment of the different layers for creating the slotted array.

FIG. 10 illustrates a side view of one embodiment of a cylindrically fed antenna structure.

FIG. 11 illustrates another embodiment of the antenna system with an outgoing wave.

FIG. 12 illustrates one embodiment of the placement of matrix drive circuitry with respect to antenna elements.

FIG. 13 illustrates one embodiment of a TFT package.

FIG. 14 is a block diagram of one embodiment of a communication system having simultaneous transmit and receive paths.

FIG. 15 illustrates one embodiment of planar top bottom load integrated dielectrics.

FIG. 16 illustrates one embodiment of a planar wrap around an absorber.

FIG. 17 illustrates one embodiment of thin resistive sheets enforced by an AMC surface.

### DETAILED DESCRIPTION

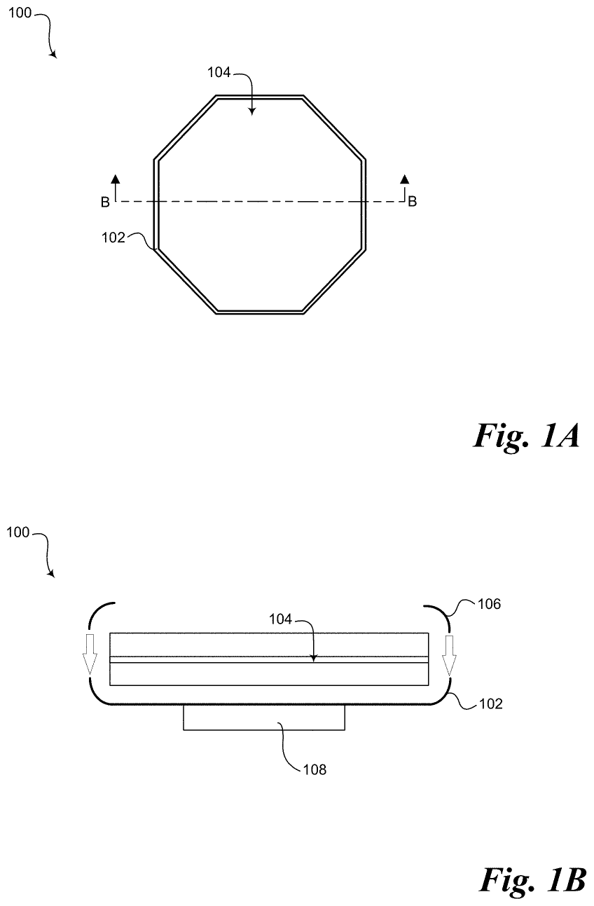

FIGS. 1A-1B together illustrate an embodiment of a flat-panel metamaterial antenna 100. Flat-panel antenna 100 includes an antenna assembly 104 positioned within a housing 102. In the illustrated embodiment housing 102, and hence flat-panel antenna 100, is octagonal, but in other embodiments housing 102 and antenna 100 can have a different shape than shown. In one embodiment, antenna assembly 104 is positioned within housing 102 and secured within housing 102 by a bezel 106 that can engage the perimeter edges of antenna assembly 104. Additional hardware 108 such as transmitter hardware, receiver hardware, or control electronic hardware for flat-panel antenna 100 can be positioned on the back of housing 102.

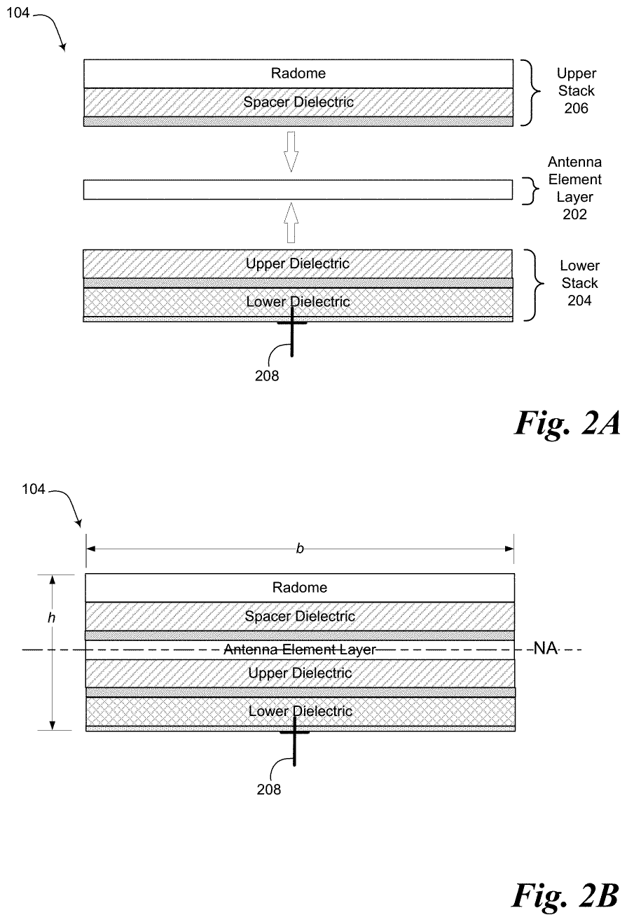

FIGS. 2A-2B together illustrate an embodiment of an antenna assembly 104; FIG. 2A is an exploded view, and FIG. 2B an assembled view. In the description that follows, the terms “upper” and “lower” are used to describe the relative positions of the upper stack, antenna element layer, and lower stack as they are shown in the figures, not to limit or mandate any particular orientation of antenna 100. Antenna assembly 104 includes an antenna element layer 202 that has formed thereon or therein an array of individual antenna elements (see, e.g., Addendum A). An upper stack 206 with one or more material layers is coupled to one side of antenna element layer 202. A lower stack 204, also having one or more material layers, is coupled to the other side of antenna element layer 202.

As used herein, “coupled” means attached to each other, with or without intervening layers or stacks (e.g., a statement that “layer X is coupled to layer Y” means that layer X is attached to layer Y, with or without additional layers between layer X and layer Y). Attachment can be via adhesives (e.g., pressure-sensitive adhesive (PSA), etc.), fasteners, clamps, or some other methods, such as, but not limited to bonding (e.g., thermal bonding, thermal welding, dispense epoxies, sonic welding, chemical bonding, adhesive bonding). In the illustrated embodiment, upper stack 206 and lower stack 204 can be coupled to antenna element layer 202 using adhesives such as epoxy, a pressure-sensitive adhesive, an adhesive sheet, or another known adhesive.

FIG. 2B illustrates one embodiment of an assembled antenna assembly 104. In one embodiment, the resulting antenna assembly has a substantially rectangular cross section of width b and height h, resulting in a cross section with an area moment of inertia I governed by the following relationship:

$$I ∝ \frac{{bh}^{3}}{12}$$

where b is the width and h the height of the assembly, as illustrated in the figure. This is not required, nor part of, other embodiments. When upper stack 206, lower stack 204, or both, are adhered to antenna element layer 202, the material properties and thicknesses of individual material layers within the upper stack and the lower stack can be selected so that when the assembly is complete the neutral axis (NA) of the assembly is located substantially in antenna element layer 202. By locating the neutral axis substantially in antenna element layer 202, stress on the antenna element layer 202—typically the most fragile and expensive layer in the assembly—is minimized when the antenna is subjected to loads. In other embodiments, the neutral axis of the assembly need not be located in the antenna element layer but can instead be located in lower stack 204 or in upper stack 206. In various embodiments, other material properties of the material layers in upper stack 206 and lower stack 204 can also be selected to reduce and potentially minimize loads on antenna element layer 202. For instance, the coefficient of thermal expansion (CTE) of materials within the upper and lower stacks can be tailored so that thermal expansion of assembly 104 does not warp the antenna, nor does it apply loads to antenna element layer 202.

A feed pin 208 can be inserted into the lower dielectric of assembly 104. Feed pin 208 injects radio frequency (RF) radiation into the lower dielectric and/or receives RF radiation from the lower dielectric. The RF radiation can be of any frequency or wavelength, including without limitation the Ka and Ku wavelength bands.

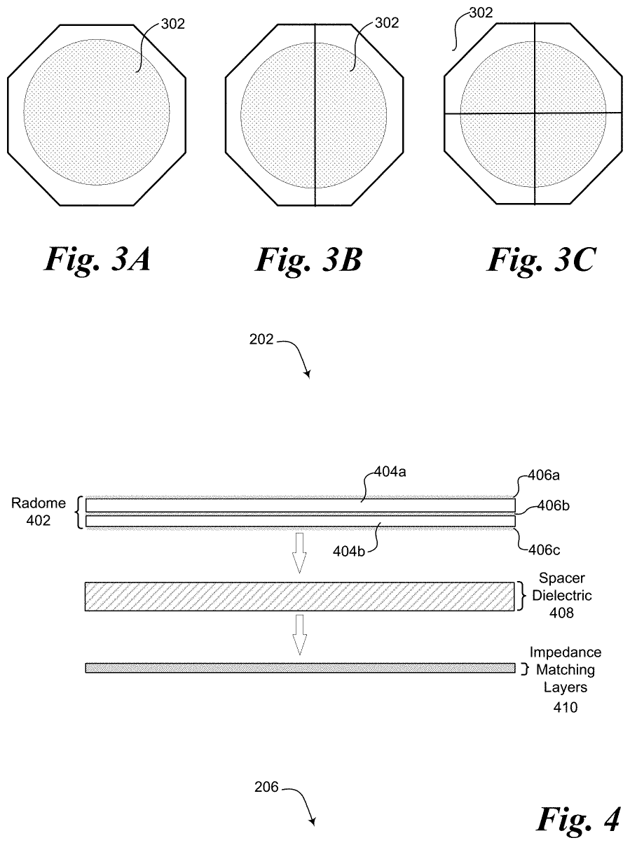

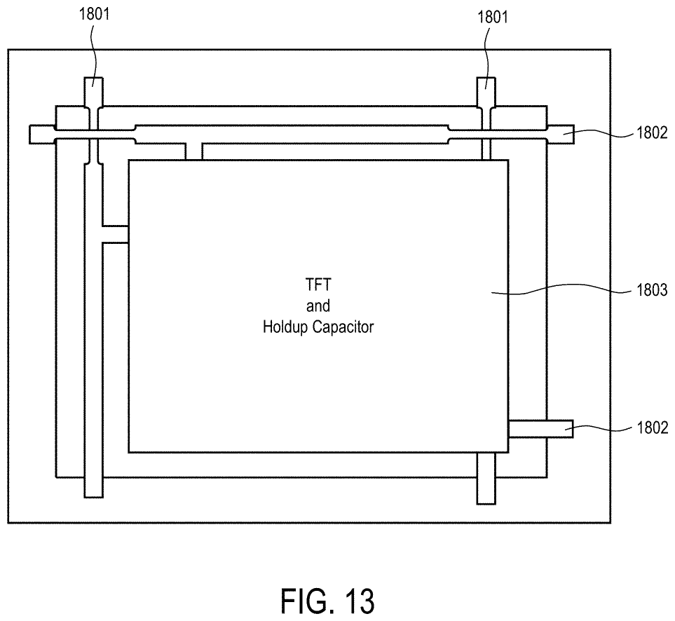

FIGS. 3A-3C illustrate embodiments of antenna element layer 202. In the illustrated embodiment, antenna element layer 202 has an octagonal plan-view shape, but in other embodiments it can have other shapes. Antenna element layer 202 includes an array 302 of individual antenna elements. In the illustrated embodiment array 302 is substantially circular, but in other embodiments the array need not be circular and can take other shapes. Embodiments of the construction of antenna element layer 202 and array 302 are illustrated below in Addenda A and B (see, e.g., FIG. 13 and associated description in Addendum A).

In FIG. 3A, antenna element layer 202 is formed as a single piece. But in other embodiments antenna element layer 202 can be formed of multiple segments. As shown in FIG. 3B, in one embodiment antenna element layer 202 can be made up of two pieces joined along a seam substantially bisecting the antenna element layer. As shown in FIG. 3C, in still other embodiments antenna element layer 202 can be made up of four pieces joined along a pair of seams. In other embodiments, antenna element layer 202 can be made of a different number of segments than shown. Embodiments of antenna element layer 202 are thin (on the order of millimeters using standard thicknesses as used in LCD manufacturing, for instance between 0.1 and 5 mm) and somewhat fragile, but in embodiments with multiple segments the seams form a weak area in the middle of the antenna element layer. As a result, all embodiments of antenna element layer 202 benefit from the structural support provided by the construction shown in FIGS. 2A-2B, although embodiments with multiple segments derive extra benefit from the construction.

In one embodiment, the antenna element layer is a flexible substrate material with varactor diodes mounted (e.g., flip chip, surface mount, etc.). In one embodiment, the material comprises polyimide, PET film, or PEN film. In such a case, the element layer is flexible. In one embodiment, the flexible antenna element layer is laminated together with the rest of the dielectric stack.

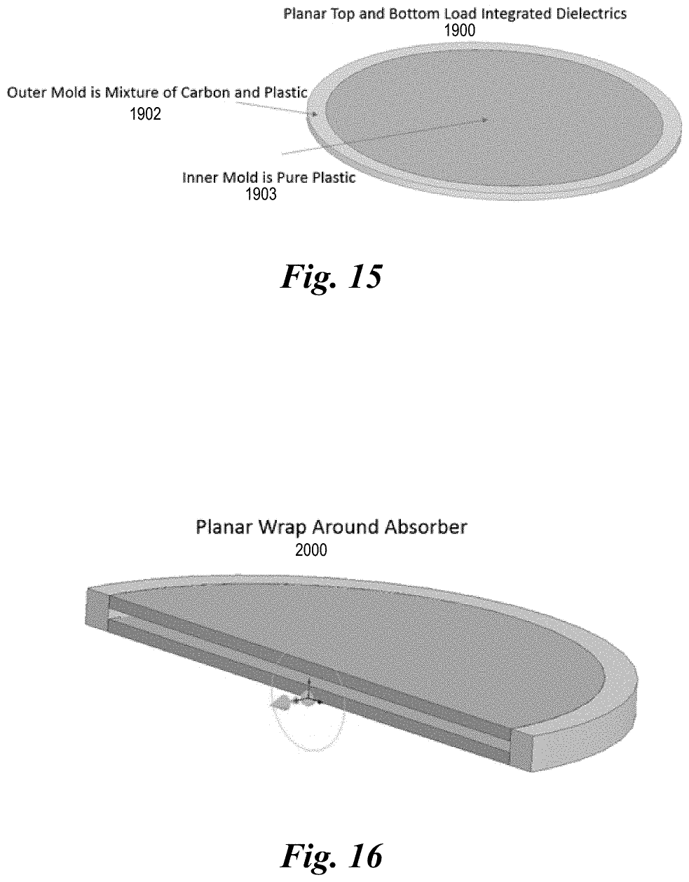

In one embodiment, an outer/inner mold is formed where the outer mold is loaded with carbon to act as absorbing material. In one embodiment, the composite structure is molded together as one planar structure. This can be done for both bottom and upper dielectrics. An example is shown in FIG. 15. Referring to FIG. 15, planar top and bottom load integrated dielectrics 1900 are shown with an inner mold 1903 is made of, for example, plastic, and an outer mold 1902, which is made of, for example, a mixture of carbon and plastic.

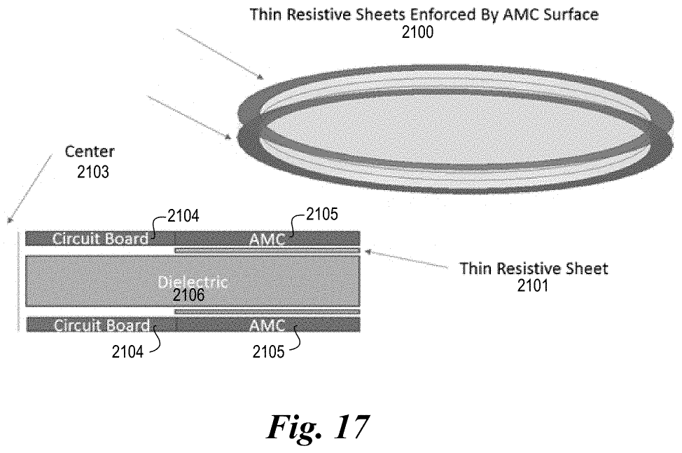

In one embodiment, a radiation absorbent material is wrapped around and adhered to the feed stack. The material can be a number of different types of materials, such as, for example, but not limited to, foam, rubber, silicone, etc. In one embodiment, the feed stack including absorber is near planar. An example of a planar wrap (2000) around an absorber is shown in FIG. 16.

In one embodiment, thin conductive sheets are placed at the edges of the dielectrics near the directional coupler printed circuit board (PCB). In one embodiment, the PCB implements a high impedance surface (AMC) such that the currents are forced to flow through the thin lossy sheets. In one embodiment, the bandwidth of this approach depends on the thickness of the PCB. In one embodiment, this stack is near planar for a thin carbon loaded fabric acting as the resistive sheet.

FIG. 17 illustrates one embodiment of thin resistive sheets enforced by an AMC structure 2100. An example thin resistive sheets, such as thin resistive sheet 2101, is shown between a dielectric 2106 and AMCs 2105 but not between a dielectric 2106 and circuit boards 2104.

FIG. 4 illustrates an embodiment of an upper stack 206. In some embodiments the plan-view shape of upper stack 206 matches the shape of antenna element layer 202—i.e., if antenna element layer 202 is octagonal, so is the upper stack. But in other embodiments upper stack 206 need not have the same plan-view shape as antenna element layer 202. In some embodiments where antenna element layer 202 includes multiple segments (see FIGS. 3B-3C), upper stack 206 will not be correspondingly segmented, but in other embodiments upper stack 206 can be segmented and the segmentation might or might not match the segmentation of the antenna element layer.

In the illustrated embodiment, the upper stack 206 includes a radome 402, but other embodiments of upper stack 206 can omit radome 402 completely or replace it with dielectric layers; in such an embodiment, the antenna would be mounted inside an environmental enclosure rather than being bonded to the radome. Among other things, when present radome 402 can provide weather-facing environmental protection for the other stacks, or a carrier for the glass layer. In one embodiment, the radome is a single-layer skin. In one embodiment, the contour of the radome is flat. In other embodiments, the radome can be curved or domed to assist in the shedding of moisture.

If present, radome 402 generally includes a stack of dielectric materials designed to match the wave impedance as it moves from the aperture into free space. In one embodiment, radome 402 includes a multi-layer stack of dielectric skins and low-dielectric layers. In the illustrated embodiment, radome 402 includes multiple layers—three layers 406a, 406b, and 406c, between which are sandwiched two dielectric layers 404, for a total of five layers.

In other embodiments, the radome has alternate configurations. Other radome configurations include, but are not limited to, 1) a solid half wave wall consisting of a single solid dielectric layer, 2) a three layer sandwich construction wherein a low dielectric layer is surrounded by two high dielectric constant layers (commonly referred to as an A sandwich design), 3) a three layer sandwich construction in which a high dielectric layer is surrounded by low dielectric constant layer (commonly referred to as an B sandwich design), and 4) multi-layer designs consisting of 5 or more dielectric layers. In all cases, the radome design embodies the selection of layer dielectric constant and thickness to obtain the desired RF response.

In one embodiment layers 406a, 406b, and 406c are made of impervious materials to seal the radome and the antenna against water intrusion and to give the radome and the antenna impact resistance, but in other embodiments one or more of layers 406 need not be an impervious material. Sandwiched between layers 406 of dielectric material are layers 404 of another dielectric: dielectric layer 404a is sandwiched between layers 406a and 406b, while dielectric layer 404b is sandwiched between layers 406b and 406c. Dielectric layers 404 have uniform thickness or variable thickness, however are not necessarily of common type. In one embodiment, all materials used in radome 402 are substantially transparent to the RF frequencies and wavelengths at which the antenna operates.

Materials used in radome dielectric layers include, but are not limited to foams, thermoplastics and thermosetting plastics. Foam types include, for example, polyethylene, polyurethane, polyisocyanurate, polyvinyl chloride, polyetherimide, and syntactic foams with densities ranging from 1 to 20 pounds per cubic foot. Thermoplastic materials include, for example, Teflon, polyethylene, polypropylene, polystyrene, acrylonitrile butadiene styrene, polyetherimide, polyvinyl chloride, and polycarbonate. Thermosetting materials include, for example, epoxy, polyester, polybutadiene, cyanate ester, polyimides, and bismaleimides. Materials can be combined with fiber reinforcements, such as, for example, glass or quartz fibers, to improve mechanical properties.

In one embodiment, spacer dielectric 408 is a dielectric layer of substantially uniform thickness and is used to separate radome 402 from impedance matching layers 410, also sometimes known as wide-angle impedance matching (WAIM) layers. Radome 402 can be adhered to one side of spacer dielectric 408, and the assembly including radome 402 and spacer dielectric 408 can then be adhered onto impedance matching layers 410. In one embodiment radome 402 is bonded to spacer dielectric 408 using adhesives and spacer dielectric 408 is also bonded to impedance matching layers 410 using adhesives that are substantially transparent to the RF radiation. In one embodiment, the adhesives can be epoxy but in other embodiments they can be alternative adhesive types such as, for example, pressure-sensitive adhesive, thermoplastic adhesive, or alternate other forms of adhesive such as adhesive sheets. In one embodiment, the adhesive layer or sheet has holes to reduce, and potentially minimize RF loss from the adhesive. In one embodiment, the pattern of adhesive is created in the adhesive deposition process, such as by offset printing, screen printing, dispensing or some equivalent method. Additionally, in one embodiment, the pattern of the adhesive, such as PSA, is created on a release liner and transferred to the feed structure from the release liner. Alternatively, the pattern may be created by a mask, and the adhesive applied through the mask. In one embodiment, the pattern comprises concentric rings of adhesive. In another embodiment, the pattern comprises dots of adhesive. In another embodiment, the adhesive is not a uniform pattern, but covers more area where more adhesion is required, more area where potential RF loss is minimal and less area where potential RF loss is greater.

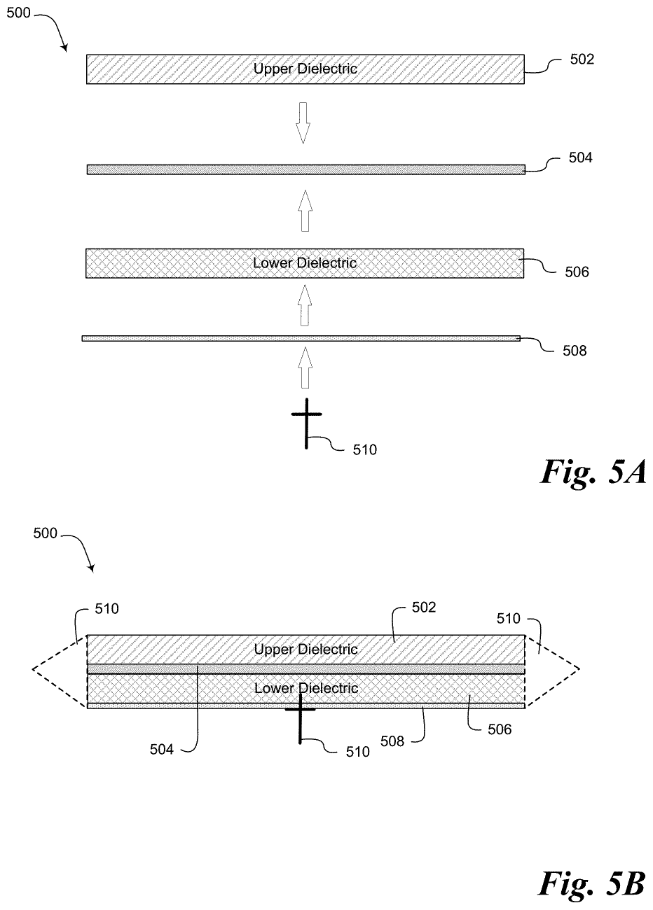

FIGS. 5A-5B together illustrate an embodiment of a lower stack 500 that can be used as lower stack 204 in assembly 104. FIG. 5A is an exploded view, FIG. 5B an assembled view. In some embodiments the plan-view shape of lower stack 500 will match the shape of antenna element layer 202—i.e., if antenna element layer 202 is octagonal, so will the lower stack. But in other embodiments lower stack 500 need not have the same plan-view shape as antenna element layer 202. In some embodiments where antenna element layer 202 includes multiple segments (see FIGS. 3B-3C), lower stack 500 will not be correspondingly segmented, but in other embodiments lower stack 500 can be segmented and the segmentation might or might not match the segmentation of the antenna element layer.

Lower stack 204 includes a conductive layer 504 sandwiched between an upper dielectric 502 and a lower dielectric 506. In various embodiments, upper dielectric 502 and lower dielectric 506 can be air, low density foams, high density foams, solid dielectric materials, or a combination of these. Upper dielectric 502 and lower dielectric 506 can be bonded to conductive layer 504 using, for example, any of the previously-mentioned or other well-known adhesives. An electrically conductive layer 508 is added to the side of lower dielectric 506 opposite the side that is bonded to electrically conductive layer 504. A feed pin 510 is inserted through metallization layer 508 into lower dielectric 506. Feed pin 510 is used to inject RF radiation into lower dielectric 506. A waveguide 510 (not shown in FIG. 5A) is positioned around the perimeter of the antenna assembly. Feed pin 510 injects RF radiation into lower dielectric and waveguide 510 directs the radiation from the lower dielectric to the upper dielectric 502. In some embodiments coupler 510 is a part of lower stack 500, but in other embodiments coupler 510 can be provided separately from the lower stack, for instance by putting it within housing 102 (see FIG. 1B).

In one embodiment, lower dielectric 506 can be a lower dielectric constant material substantially transparent to RF radiation and upper dielectric 502 can be made of a higher dielectric constant material used to control the propagation of the RF radiation entering the upper dielectric 502 from coupler 510. In one embodiment, electrically conductive layer 504 can be a metal, but in other embodiments it can be some a nonmetallic conductor; in any event, in one embodiment electrically conductive layer 504 should be reflective, not transparent, to RF radiation. Conductive layer 508 is similarly reflective to RF radiation, so that electrically conductive layer 504 and conductive layer 508 together keep the RF radiation propagating through the lower dielectric, rather than allowing radiation to exit through the top or bottom of the lower dielectric 506.

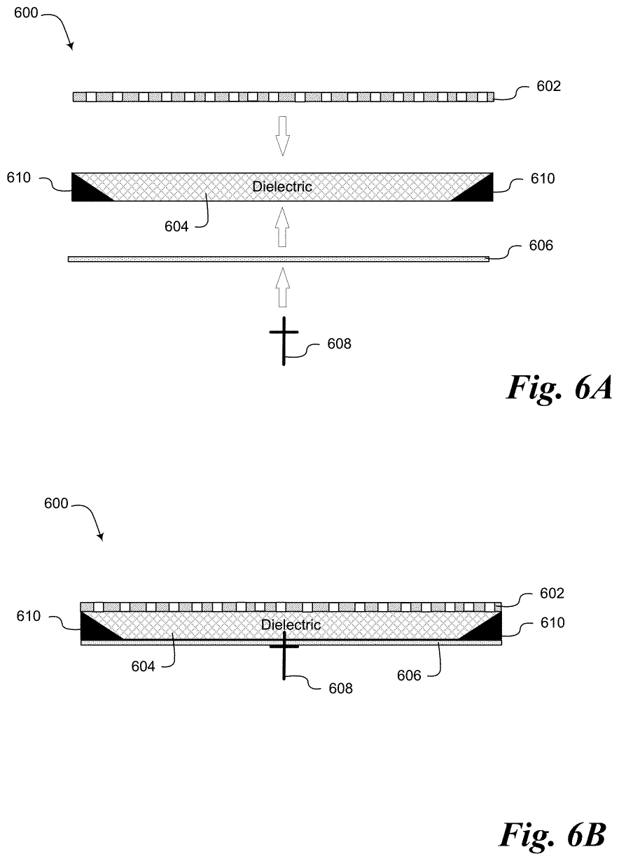

FIGS. 6A-6B together illustrate an alternative embodiment of lower stack 600 that can be used as lower stack 204 in antenna assembly 104; FIG. 6A is an exploded view, FIG. 6B an assembled view. In some embodiments, the plan-view shape of lower stack 600 matches the shape of antenna element layer 202—i.e., if antenna element layer 202 is octagonal, so is the lower stack. But in other embodiments lower stack 600 need not have the same plan-view shape as antenna element layer 202. In some embodiments where antenna element layer 202 includes multiple segments (see FIGS. 3B-3C), lower stack 600 will not be correspondingly segmented, but in other embodiments lower stack 600 can be segmented and the segmentation might or might not match the segmentation of the antenna element layer.

In lower stack 600, a patterned conductive layer 602 is formed on one side of the dielectric 604 that controls the rate of energy transfer from lower to upper stacks. In one embodiment, patterned conductive layer 602 is a layer including a set of concentric electrically conductive rings 602 formed on one side of a dielectric 604. A conductive layer 606 is formed on the side of dielectric 604 opposite layer 602. Terminations 610 are positioned around the perimeter of waveguide 604 to absorb RF radiation and prevent its exit from the perimeter of lower dielectric 604; in one embodiment, terminations 610 can include a termination ring positioned around the perimeter of dielectric 604. A feed pin 608 is inserted through conductive layer 606 into lower dielectric 604 to inject RF radiation into the dielectric. When injected into the dielectric from pin 608, the RF radiation will propagate radially away from feed pin 608 toward terminations 610. As it propagates, most of the RF radiation will exit through the spaces in patterned conducive layer 602—that is, most of the RF radiation will transfer to the upper stack through coupling features. Whatever RF radiation doesn't exit through the rings in ring structure 602 is absorbed by terminations 610 around the perimeter. In one embodiment lower dielectric 604 is made of a dielectric that is substantially transparent to the RF frequency or wavelength of RF radiation injected into it by feed pin 608—in other words, it is transparent to RF frequencies in which the antenna operates.

In one embodiment, patterned conductive layers 410, 504 and 602, as discussed above, are realized using various methods. In one embodiment, the patterned conductive layer consists of a solid copper layer laminated to a composite substrate, and the pattern is realized using subtractive (e.g., etching, etc.) methods. In another embodiment, the conductive pattern is applied using additive methods (e.g., silk screen, ink jet printing, etc.) to a composite substrate or a thermoplastic film (e.g., polyester, Kapton, etc.).

Similarly, conductive layers 508 and 606 can be implemented using various manufacturing approaches. Approaches include electroless plating, silk screening, or bonding of conductive sheets onto dielectric layers (e.g. 506 or 610). In one embodiment, conductive layers 508 and 606 are solid metallic layers (e.g., aluminum, steel, copper, etc.).

Bonding of upper and lower stacks components can be accomplished with a variety of methods. Possible bonding methods include 1) pressure sensitive and heat activated film adhesives, 2) thermosetting adhesives, and 3) thermal fusing of thermoplastic materials. Thermal fusing has the advantage of not requiring additional adhesive layers. Possible fabrication methods include vacuum forming, vacuum bag curing at room and elevated temperatures, autoclave curing, resin injection molding, and compression molding.

### Examples of Antenna Embodiments

The techniques described above may be used with flat panel antennas. Embodiments of such flat panel antennas are disclosed. The flat panel antennas include one or more arrays of antenna elements on an antenna aperture. In one embodiment, the antenna elements comprise liquid crystal cells. In one embodiment, the flat panel antenna is a cylindrically fed antenna that includes matrix drive circuitry to uniquely address and drive each of the antenna elements that are not placed in rows and columns. In one embodiment, the elements are placed in rings.

In one embodiment, the antenna aperture having the one or more arrays of antenna elements is comprised of multiple segments coupled together. When coupled together, the combination of the segments form closed concentric rings of antenna elements. In one embodiment, the concentric rings are concentric with respect to the antenna feed.

### Examples of Antenna Systems

In one embodiment, the flat panel antenna is part of a metamaterial antenna system. Embodiments of a metamaterial antenna system for communications satellite earth stations are described. In one embodiment, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. Note that embodiments of the antenna system also can be used in earth stations that are not on mobile platforms (e.g., fixed or transportable earth stations).

In one embodiment, the antenna system uses surface scattering metamaterial technology to form and steer transmit and receive beams through separate antennas. In one embodiment, the antenna systems are analog systems, in contrast to antenna systems that employ digital signal processing to electrically form and steer beams (such as phased array antennas).

In one embodiment, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

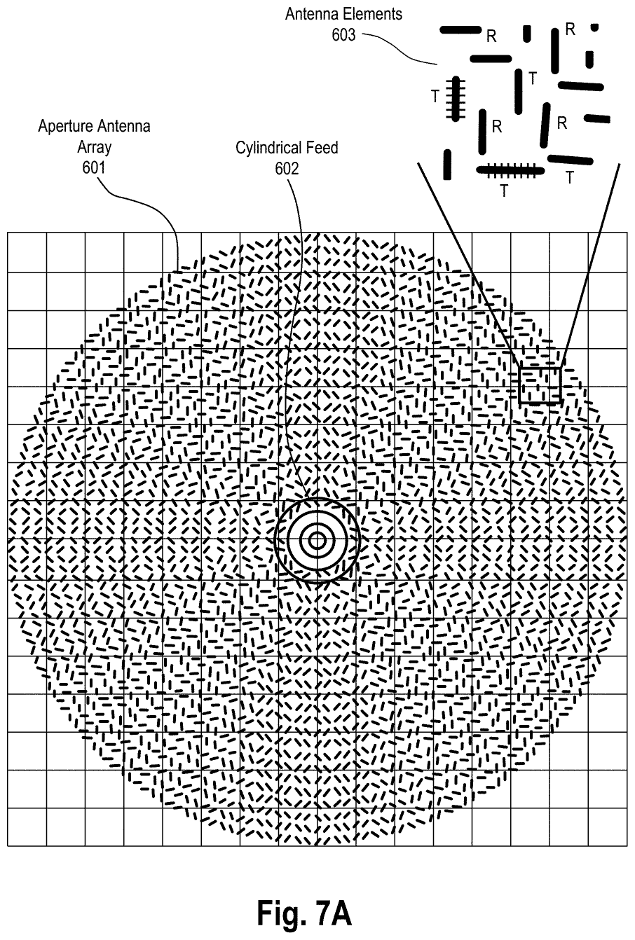

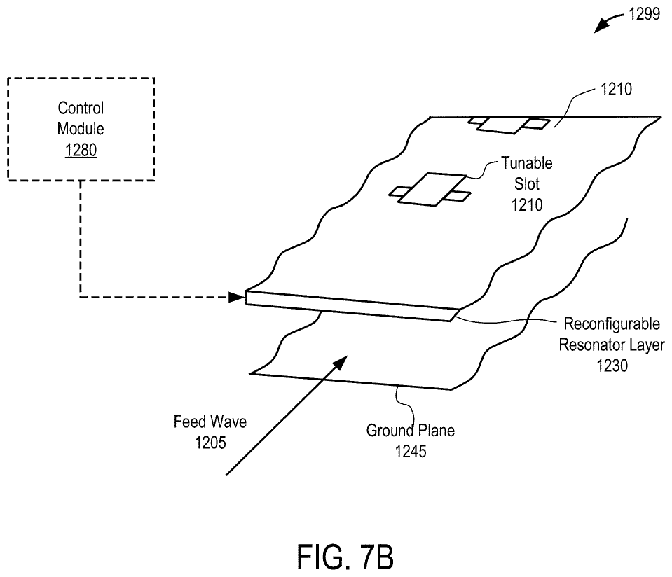

FIG. 7A illustrates the schematic of one embodiment of a cylindrically fed holographic radial aperture antenna. Referring to FIG. 7B, the antenna aperture has one or more arrays 601 of antenna elements 603 that are placed in concentric rings around an input feed 602 of the cylindrically fed antenna. In one embodiment, antenna elements 603 are radio frequency (RF) resonators that radiate RF energy. In one embodiment, antenna elements 603 comprise both Rx and Tx irises that are interleaved and distributed on the whole surface of the antenna aperture. Such Rx and Tx irises, or slots, may be in groups of three or more sets where each set is for a separately and simultaneously controlled band. Examples of such antenna elements with irises are described in greater detail below. Note that the RF resonators described herein may be used in antennas that do not include a cylindrical feed.

In one embodiment, the antenna includes a coaxial feed that is used to provide a cylindrical wave feed via input feed 602. In one embodiment, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In one embodiment, antenna elements 603 comprise irises and the aperture antenna of FIG. 7B is used to generate a main beam shaped by using excitation from a cylindrical feed wave for radiating irises through tunable liquid crystal (LC) material. In one embodiment, the antenna can be excited to radiate a horizontally or vertically polarized electric field at desired scan angles.

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor. As would be understood by those skilled in the art, LC in the context of CELC refers to inductance-capacitance, as opposed to liquid crystal.

In one embodiment, a liquid crystal (LC) is disposed in the gap around the scattering element. This LC is driven by the direct drive embodiments described above. In one embodiment, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in one embodiment, the liquid crystal integrates an on/off switch for the transmission of energy from the guided wave to the CELC. When switched on, the CELC emits an electromagnetic wave like an electrically small dipole antenna. Note that the teachings herein are not limited to having a liquid crystal that operates in a binary fashion with respect to energy transmission.

In one embodiment, the feed geometry of this antenna system allows the antenna elements to be positioned at forty-five-degree (45°) angles to the vector of the wave in the wave feed. Note that other positions may be used (e.g., at 40o angles). This position of the elements enables control of the free space wave received by or transmitted/radiated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In one embodiment, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In one embodiment, the control structure for the antenna system has 2 main components: the antenna array controller, which includes drive electronics, for the antenna system, is below the wave scattering structure (of surface scattering antenna elements such as described herein), while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude or duty cycle of an AC bias signal to that element.

In one embodiment, the antenna array controller also contains a microprocessor executing the software. The control structure may also incorporate sensors (e.g., a GPS receiver, a three-axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In one embodiment, multistate control is used in which various elements are turned on and off to varying levels, further approximating a sinusoidal control pattern, as opposed to a square wave (i.e., a sinusoid gray shade modulation pattern). In one embodiment, some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In one embodiment, the antenna system produces one steerable beam for the uplink antenna and one steerable beam for the downlink antenna. In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

FIG. 7B illustrates a perspective view of one row of antenna elements that includes a ground plane and a reconfigurable resonator layer. Reconfigurable resonator layer 1230 includes an array of tunable slots 1210. The array of tunable slots 1210 can be configured to point the antenna in a desired direction. Each of the tunable slots can be tuned/adjusted by varying a voltage across the liquid crystal.

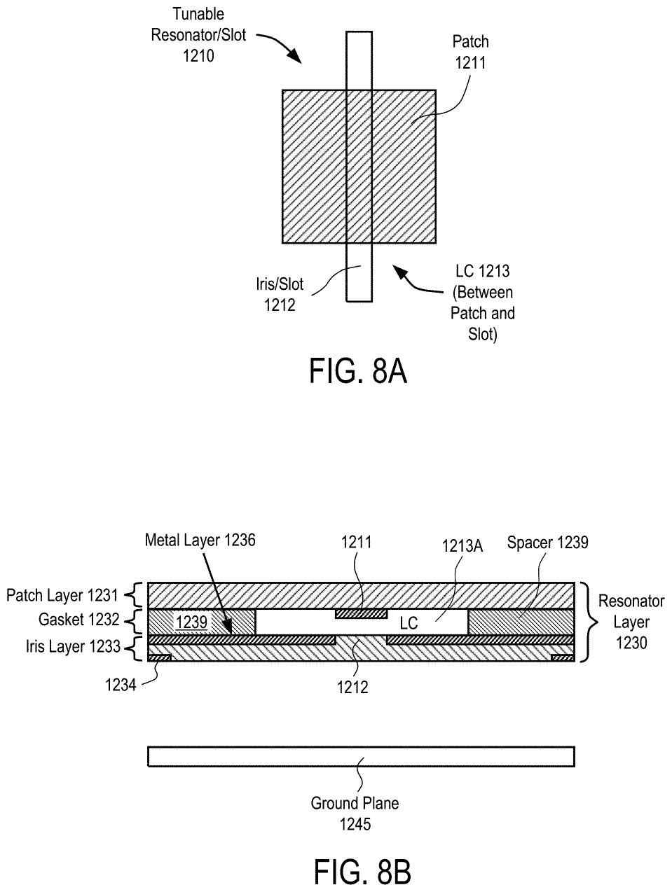

Control module, or controller, 1280 is coupled to reconfigurable resonator layer 1230 to modulate the array of tunable slots 1210 by varying the voltage across the liquid crystal in FIG. 8A. Control module 1280 may include a Field Programmable Gate Array (“FPGA”), a microprocessor, a controller, System-on-a-Chip (SoC), or other processing logic. In one embodiment, control module 1280 includes logic circuitry (e.g., multiplexer) to drive the array of tunable slots 1210. In one embodiment, control module 1280 receives data that includes specifications for a holographic diffraction pattern to be driven onto the array of tunable slots 1210. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 1280 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 1205 (approximately 20 GHz in some embodiments). To transform a feed wave into a radiated beam (either for transmitting or receiving purposes), an interference pattern is calculated between the desired RF beam (the object beam) and the feed wave (the reference beam). The interference pattern is driven onto the array of tunable slots 1210 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system. The holographic diffraction pattern contains the excitation of each element and is calculated by w_{hologram}=wᵢₙ*wₒᵤₜ, with wᵢₙ as the wave equation in the waveguide and wₒᵤₜ the wave equation on the outgoing wave.

FIG. 8A illustrates one embodiment of a tunable resonator/slot 1210. Tunable slot 1210 includes an iris/slot 1212, a radiating patch 1211, and liquid crystal 1213 disposed between iris 1212 and patch 1211. In one embodiment, radiating patch 1211 is co-located with iris 1212.

FIG. 8B illustrates a cross section view of one embodiment of a physical antenna aperture. The antenna aperture includes ground plane 1245, and a metal layer 1236 within iris layer 1233, which is included in reconfigurable resonator layer 1230. In one embodiment, the antenna aperture of FIG. 8B includes a plurality of tunable resonator/slots 1210 of FIG. 8A. Iris/slot 1212 is defined by openings in metal layer 1236. A feed wave, such as feed wave 1205 of FIG. 8A, may have a microwave frequency compatible with satellite communication channels. The feed wave propagates between ground plane 1245 and resonator layer 1230.

Reconfigurable resonator layer 1230 also includes gasket layer 1232 and patch layer 1231. Gasket layer 1232 is disposed between patch layer 1231 and iris layer 1233. Note that in one embodiment, a spacer could replace gasket layer 1232. In one embodiment, iris layer 1233 is a printed circuit board (“PCB”) that includes a copper layer as metal layer 1236. In one embodiment, iris layer 1233 is glass. Iris layer 1233 may be other types of substrates.

Openings may be etched in the copper layer to form slots 1212. In one embodiment, iris layer 1233 is conductively coupled by a conductive bonding layer to another structure (e.g., a waveguide) in FIG. 8B. Note that in an embodiment the iris layer is not conductively coupled by a conductive bonding layer and is instead interfaced with a non-conducting bonding layer.

Patch layer 1231 may also be a PCB that includes metal as radiating patches 1211. In one embodiment, gasket layer 1232 includes spacers 1239 that provide a mechanical standoff to define the dimension between metal layer 1236 and patch 1211. In one embodiment, the spacers are 75 microns, but other sizes may be used (e.g., 3-200 mm). As mentioned above, in one embodiment, the antenna aperture of FIG. 8B includes multiple tunable resonator/slots, such as tunable resonator/slot 1210 includes patch 1211, liquid crystal 1213, and iris 1212 of FIG. 8A. The chamber for liquid crystal 1213 is defined by spacers 1239, iris layer 1233 and metal layer 1236. When the chamber is filled with liquid crystal, patch layer 1231 can be laminated onto spacers 1239 to seal liquid crystal within resonator layer 1230.

A voltage between patch layer 1231 and iris layer 1233 can be modulated to tune the liquid crystal in the gap between the patch and the slots (e.g., tunable resonator/slot 1210). Adjusting the voltage across liquid crystal 1213 varies the capacitance of a slot (e.g., tunable resonator/slot 1210). Accordingly, the reactance of a slot (e.g., tunable resonator/slot 1210) can be varied by changing the capacitance. Resonant frequency of slot 1210 also changes according to the equation f=1/2π\sqrt{LC} where f is the resonant frequency of slot 1210 and L and C are the inductance and capacitance of slot 1210, respectively. The resonant frequency of slot 1210 affects the energy radiated from feed wave 1205 propagating through the waveguide. As an example, if feed wave 1205 is 20 GHz, the resonant frequency of a slot 1210 may be adjusted (by varying the capacitance) to 17 GHz so that the slot 1210 couples substantially no energy from feed wave 1205. Or, the resonant frequency of a slot 1210 may be adjusted to 20 GHz so that the slot 1210 couples energy from feed wave 1205 and radiates that energy into free space. Although the examples given are binary (fully radiating or not radiating at all), full gray scale control of the reactance, and therefore the resonant frequency of slot 1210 is possible with voltage variance over a multi-valued range. Hence, the energy radiated from each slot 1210 can be finely controlled so that detailed holographic diffraction patterns can be formed by the array of tunable slots.

In one embodiment, tunable slots in a row are spaced from each other by λ/5. Other spacings may be used. In one embodiment, each tunable slot in a row is spaced from the closest tunable slot in an adjacent row by λ/2, and, thus, commonly oriented tunable slots in different rows are spaced by λ/4, though other spacings are possible (e.g., λ/5, λ/6.3). In another embodiment, each tunable slot in a row is spaced from the closest tunable slot in an adjacent row by λ/3.

Embodiments use reconfigurable metamaterial technology, such as described in U.S. patent application Ser. No. 14/550,178, entitled “Dynamic Polarization and Coupling Control from a Steerable Cylindrically Fed Holographic Antenna”, filed Nov. 21, 2014 and U.S. patent application Ser. No. 14/610,502, entitled “Ridged Waveguide Feed Structures for Reconfigurable Antenna”, filed Jan. 30, 2015.

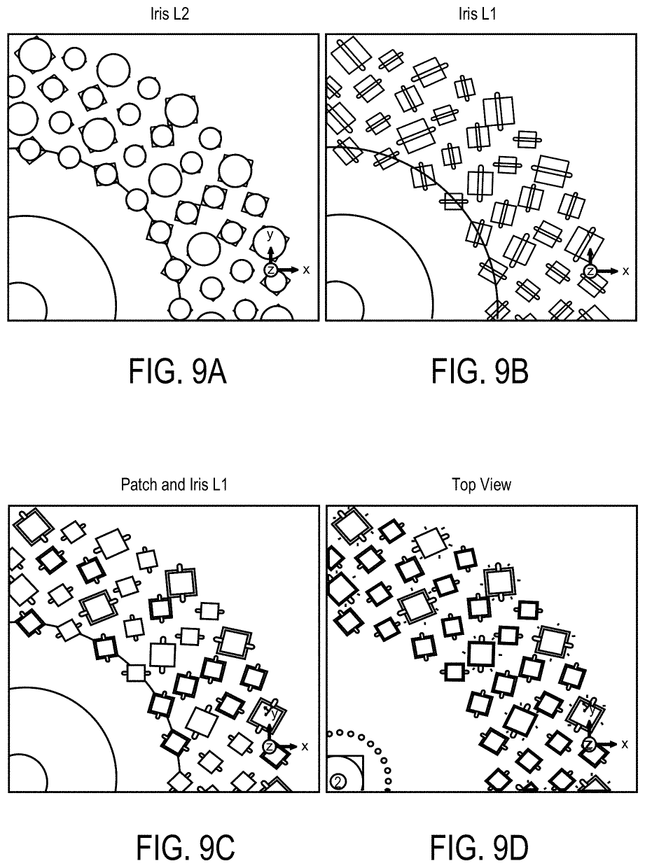

FIGS. 9A-D illustrate one embodiment of the different layers for creating the slotted array. The antenna array includes antenna elements that are positioned in rings, such as the example rings shown in FIG. 1A. Note that in this example the antenna array has two different types of antenna elements that are used for two different types of frequency bands.

FIG. 9A illustrates a portion of the first iris board layer with locations corresponding to the slots. Referring to FIG. 9A, the circles are open areas/slots in the metallization in the bottom side of the iris substrate, and are for controlling the coupling of elements to the feed (the feed wave). Note that this layer is an optional layer and is not used in all designs. FIG. 9B illustrates a portion of the second iris board layer containing slots. FIG. 9C illustrates patches over a portion of the second iris board layer. FIG. 9D illustrates a top view of a portion of the slotted array.

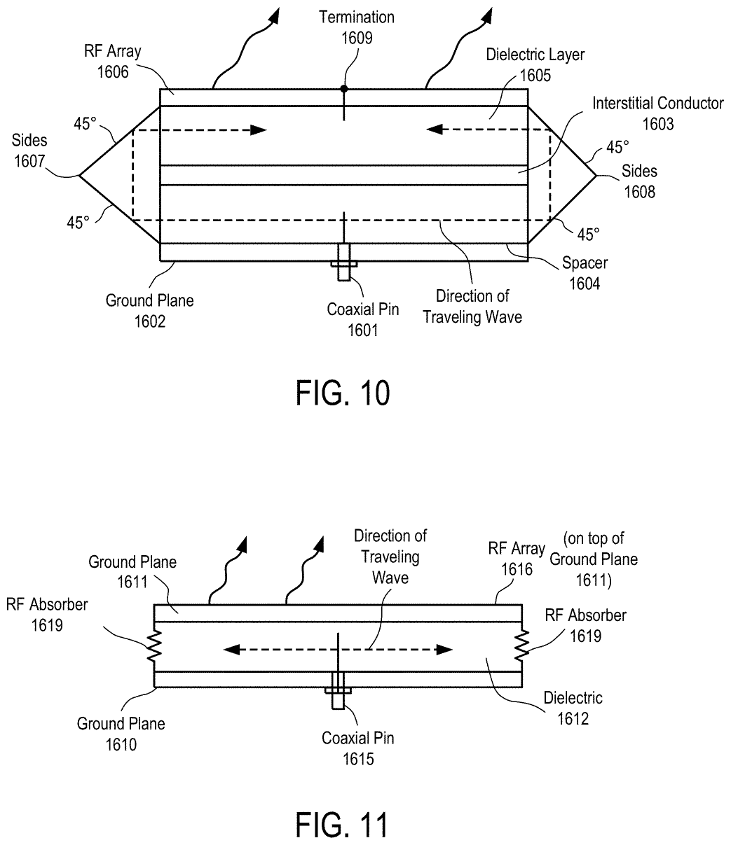

FIG. 10 illustrates a side view of one embodiment of a cylindrically fed antenna structure. The antenna produces an inwardly travelling wave using a double layer feed structure (i.e., two layers of a feed structure). In one embodiment, the antenna includes a circular outer shape, though this is not required. That is, non-circular inward travelling structures can be used. In one embodiment, the antenna structure in FIG. 10 includes a coaxial feed, such as, for example, described in U.S. Publication No. 2015/0236412, entitled “Dynamic Polarization and Coupling Control from a Steerable Cylindrically Fed Holographic Antenna”, filed on Nov. 21, 2014.

Referring to FIG. 10, a coaxial pin 1601 is used to excite the field on the lower level of the antenna. In one embodiment, coaxial pin 1601 is a 50Ω coax pin that is readily available. Coaxial pin 1601 is coupled (e.g., bolted) to the bottom of the antenna structure, which is conducting ground plane 1602.

Separate from conducting ground plane 1602 is interstitial conductor 1603, which is an internal conductor. In one embodiment, conducting ground plane 1602 and interstitial conductor 1603 are parallel to each other. In one embodiment, the distance between ground plane 1602 and interstitial conductor 1603 is 0.1-0.15″. In another embodiment, this distance may be λ/2, where λ is the wavelength of the travelling wave at the frequency of operation.

Ground plane 1602 is separated from interstitial conductor 1603 via a spacer 1604. In one embodiment, spacer 1604 is a foam or air-like spacer. In one embodiment, spacer 1604 comprises a plastic spacer.

On top of interstitial conductor 1603 is dielectric layer 1605. In one embodiment, dielectric layer 1605 is plastic. The purpose of dielectric layer 1605 is to slow the travelling wave relative to free space velocity. In one embodiment, dielectric layer 1605 slows the travelling wave by 30% relative to free space. In one embodiment, the range of indices of refraction that are suitable for beam forming are 1.2-1.8, where free space has by definition an index of refraction equal to 1. Other dielectric spacer materials, such as, for example, plastic, may be used to achieve this effect. Note that materials other than plastic may be used as long as they achieve the desired wave slowing effect. Alternatively, a material with distributed structures may be used as dielectric 1605, such as periodic sub-wavelength metallic structures that can be machined or lithographically defined, for example.

An RF-array 1606 is on top of dielectric 1605. In one embodiment, the distance between interstitial conductor 1603 and RF-array 1606 is 0.1-0.15″. In another embodiment, this distance may be λ_{eff}/2, where λ_{eff} is the effective wavelength in the medium at the design frequency.

The antenna includes sides 1607 and 1608. Sides 1607 and 1608 are angled to cause a travelling wave feed from coax pin 1601 to be propagated from the area below interstitial conductor 1603 (the spacer layer) to the area above interstitial conductor 1603 (the dielectric layer) via reflection. In one embodiment, the angle of sides 1607 and 1608 are at 45° angles. In an alternative embodiment, sides 1607 and 1608 could be replaced with a continuous radius to achieve the reflection. While FIG. 10 shows angled sides that have angle of 45 degrees, other angles that accomplish signal transmission from lower level feed to upper level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step. The steps on one end of the antenna go around the dielectric layer, interstitial the conductor, and the spacer layer. The same two steps are at the other ends of these layers.

In operation, when a feed wave is fed in from coaxial pin 1601, the wave travels outward concentrically oriented from coaxial pin 1601 in the area between ground plane 1602 and interstitial conductor 1603. The concentrically outgoing waves are reflected by sides 1607 and 1608 and travel inwardly in the area between interstitial conductor 1603 and RF array 1606. The reflection from the edge of the circular perimeter causes the wave to remain in phase (i.e., it is an in-phase reflection). The travelling wave is slowed by dielectric layer 1605. At this point, the travelling wave starts interacting and exciting with elements in RF array 1606 to obtain the desired scattering.

To terminate the travelling wave, a termination 1609 is included in the antenna at the geometric center of the antenna. In one embodiment, termination 1609 comprises a pin termination (e.g., a 50Ω pin). In another embodiment, termination 1609 comprises an RF absorber that terminates unused energy to prevent reflections of that unused energy back through the feed structure of the antenna. These could be used at the top of RF array 1606.

FIG. 11 illustrates another embodiment of the antenna system with an outgoing wave. Referring to FIG. 11, two ground planes 1610 and 1611 are substantially parallel to each other with a dielectric layer 1612 (e.g., a plastic layer, etc.) in between ground planes. RF absorbers 1619 (e.g., resistors) couple the two ground planes 1610 and 1611 together. A coaxial pin 1615 (e.g., 50Ω) feeds the antenna. An RF array 1616 is on top of dielectric layer 1612 and ground plane 1611.

In operation, a feed wave is fed through coaxial pin 1615 and travels concentrically outward and interacts with the elements of RF array 1616.

The cylindrical feed in both the antennas of FIGS. 10 and 11 improves the service angle of the antenna. Instead of a service angle of plus or minus forty-five degrees azimuth (±45° Az) and plus or minus twenty-five degrees elevation (±25° El), in one embodiment, the antenna system has a service angle of seventy-five degrees (75°) from the bore sight in all directions. As with any beam forming antenna comprised of many individual radiators, the overall antenna gain is dependent on the gain of the constituent elements, which themselves are angle-dependent. When using common radiating elements, the overall antenna gain typically decreases as the beam is pointed further off bore sight. At 75 degrees off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

### Array of Wave Scattering Elements

RF array 1606 of FIG. 10 and RF array 1616 of FIG. 11 include a wave scattering subsystem that includes a group of patch antennas (i.e., scatterers) that act as radiators. This group of patch antennas comprises an array of scattering metamaterial elements.

In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave.

The phase of the electromagnetic wave generated by a single CELC can be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty-five-degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

### Cell Placement

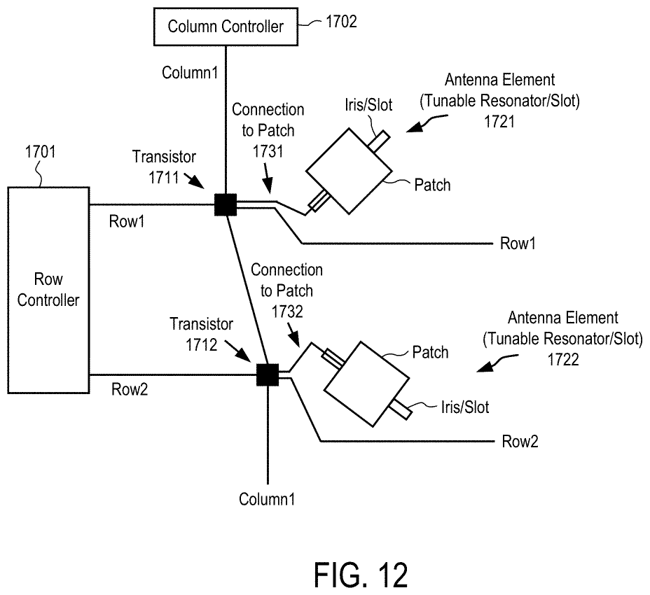

In one embodiment, the antenna elements are placed on the cylindrical feed antenna aperture in a way that allows for a systematic matrix drive circuit. The placement of the cells includes placement of the transistors for the matrix drive. FIG. 12 illustrates one embodiment of the placement of matrix drive circuitry with respect to antenna elements. Referring to FIG. 12, row controller 1701 is coupled to transistors 1711 and 1712, via row select signals Row1 and Row2, respectively, and column controller 1702 is coupled to transistors 1711 and 1712 via column select signal Column1. Transistor 1711 is also coupled to antenna element 1721 via connection to patch 1731, while transistor 1712 is coupled to antenna element 1722 via connection to patch 1732.

In an initial approach to realize matrix drive circuitry on the cylindrical feed antenna with unit cells placed in a non-regular grid, two steps are performed. In the first step, the cells are placed on concentric rings and each of the cells is connected to a transistor that is placed beside the cell and acts as a switch to drive each cell separately. In the second step, the matrix drive circuitry is built in order to connect every transistor with a unique address as the matrix drive approach requires. Because the matrix drive circuit is built by row and column traces (similar to LCDs) but the cells are placed on rings, there is no systematic way to assign a unique address to each transistor. This mapping problem results in very complex circuitry to cover all the transistors and leads to a significant increase in the number of physical traces to accomplish the routing. Because of the high density of cells, those traces disturb the RF performance of the antenna due to coupling effect. Also, due to the complexity of traces and high packing density, the routing of the traces cannot be accomplished by commercially available layout tools.

In one embodiment, the matrix drive circuitry is predefined before the cells and transistors are placed. This ensures a minimum number of traces that are necessary to drive all the cells, each with a unique address. This strategy reduces the complexity of the drive circuitry and simplifies the routing, which subsequently improves the RF performance of the antenna.

More specifically, in one approach, in the first step, the cells are placed on a regular rectangular grid composed of rows and columns that describe the unique address of each cell. In the second step, the cells are grouped and transformed to concentric circles while maintaining their address and connection to the rows and columns as defined in the first step. A goal of this transformation is not only to put the cells on rings but also to keep the distance between cells and the distance between rings constant over the entire aperture. In order to accomplish this goal, there are several ways to group the cells.

In one embodiment, a TFT package is used to enable placement and unique addressing in the matrix drive. FIG. 13 illustrates one embodiment of a TFT package. Referring to FIG. 13, a TFT and a hold capacitor 1803 is shown with input and output ports. There are two input ports connected to traces 1801 and two output ports connected to traces 1802 to connect the TFTs together using the rows and columns. In one embodiment, the row and column traces cross in 90° angles to reduce, and potentially minimize, the coupling between the row and column traces. In one embodiment, the row and column traces are on different layers.

### An Example of a Full Duplex Communication System

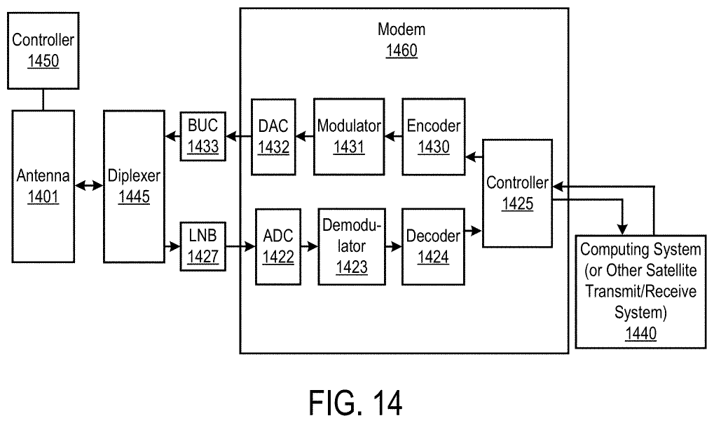

In another embodiment, the combined antenna apertures are used in a full duplex communication system. FIG. 14 is a block diagram of an embodiment of a communication system having simultaneous transmit and receive paths. While only one transmit path and one receive path are shown, the communication system may include more than one transmit path and/or more than one receive path.

Referring to FIG. 14, antenna 1401 includes two spatially interleaved antenna arrays operable independently to transmit and receive simultaneously at different frequencies as described above. In one embodiment, antenna 1401 is coupled to diplexer 1445. The coupling may be by one or more feeding networks. In one embodiment, in the case of a radial feed antenna, diplexer 1445 combines the two signals and the connection between antenna 1401 and diplexer 1445 is a single broad-band feeding network that can carry both frequencies.

Diplexer 1445 is coupled to a low noise block down converter (LNBs) 1427, which performs a noise filtering function and a down conversion and amplification function in a manner well-known in the art. In one embodiment, LNB 1427 is in an out-door unit (ODU). In another embodiment, LNB 1427 is integrated into the antenna apparatus. LNB 1427 is coupled to a modem 1460, which is coupled to computing system 1440 (e.g., a computer system, modem, etc.).

Modem 1460 includes an analog-to-digital converter (ADC) 1422, which is coupled to LNB 1427, to convert the received signal output from diplexer 1445 into digital format. Once converted to digital format, the signal is demodulated by demodulator 1423 and decoded by decoder 1424 to obtain the encoded data on the received wave. The decoded data is then sent to controller 1425, which sends it to computing system 1440.

Modem 1460 also includes an encoder 1430 that encodes data to be transmitted from computing system 1440. The encoded data is modulated by modulator 1431 and then converted to analog by digital-to-analog converter (DAC) 1432. The analog signal is then filtered by a BUC (up-convert and high pass amplifier) 1433 and provided to one port of diplexer 1445. In one embodiment, BUC 1433 is in an out-door unit (ODU).

Diplexer 1445 operating in a manner well-known in the art provides the transmit signal to antenna 1401 for transmission.

Controller 1450 controls antenna 1401, including the two arrays of antenna elements on the single combined physical aperture.

The communication system would be modified to include the combiner/arbiter described above. In such a case, the combiner/arbiter after the modem but before the BUC and LNB.

Note that the full duplex communication system shown in FIG. 14 has a number of applications, including but not limited to, internet communication, vehicle communication (including software updating), etc.

There is a number of example embodiments described herein.

Example 1 is an antenna assembly comprising: an antenna element layer having an upper side and a lower side; a first set of one or more layers forming an upper stack bonded to the upper side of the antenna element layer and being are at least partially transparent to radio frequency (RF) radiation; and a second set of one or more layers forming a lower stack bonded to the lower side of the antenna element layer, the antenna element layer, upper stack and lower stack being bonded together to form a composite stack.

Example 2 is the antenna assembly of example 1 that may optionally include that the upper stack comprises: one or more impedance matching layers; and a dielectric bonded to the one or more impedance matching layers.

Example 3 is the antenna assembly of example 2 that may optionally include that the upper stack further comprises a radome bonded to the dielectric, such that the dielectric is between the radome and the one or more impedance matching layers.

Example 4 is the antenna assembly of example 3 that may optionally include that the radome layer comprises a multi-layer composite consisting of dielectric skins and low dielectric layers.

Example 5 is the antenna assembly of example 1 that may optionally include that the upper stack and the lower stack are bonded to the antenna element layer with adhesives.

Example 6 is the antenna assembly of example 5 that may optionally include further comprises at least one adhesive layer between layers of the upper stack, lower stack or between the antenna element layer and one or both of the upper and lower stacks that includes one or more holes.

Example 7 is the antenna assembly of example 1 that may optionally include that the upper stack and the lower stack are bonded to the antenna element layer using thermal bonding, thermal welding, dispense epoxies, sonic welding, or chemical bonding.

Example 8 is the antenna assembly of example 1 that may optionally include further comprising one or more planar top and bottom load integrated dielectrics included and the composite structure is molded together as one planar structure.

Example 9 is the antenna assembly of example 1 that may optionally include that the antenna element layer comprises a flexible material.

Example 10 is the antenna assembly of example 1 that may optionally include that the dimensions and material properties of the one or more layers in the upper stack and the dimensions and material properties of the one or more layers in the lower stack reduce stress on the antenna element layer.

Example 11 is the antenna assembly of example 1 that may optionally include that the lower stack comprises: a lower dielectric made of a material at least partially transparent to RF radiation; an upper dielectric made of a material at least partially transparent to RF radiation; a conductive layer sandwiched between the lower dielectric and the upper dielectric; and an electrically conductive layer formed on the side of the lower dielectric opposite where the lower dielectric is in contact with the electrically conductive layer.

Example 12 is the antenna assembly of example 11 that may optionally include a structure positioned along the perimeter of the lower stack to direct RF radiation from the lower dielectric into the upper dielectric.

Example 13 is the antenna assembly of example 1 that may optionally include that a neutral axis of the antenna assembly substantially coincides with the antenna element layer.

Example 14 is an antenna comprising: a housing; an antenna assembly positioned within the housing, the antenna assembly comprising: an antenna element layer having an upper side and a lower side; a first set of one or more layers forming an upper stack bonded to the upper side of the antenna element layer and being are at least partially transparent to radio frequency (RF) radiation, wherein the upper stack comprises one or more impedance matching layers, and a dielectric bonded to the one or more impedance matching layers; a second set of one or more layers forming a lower stack bonded to the lower side of the antenna element layer, the antenna element layer, upper stack and lower stack being bonded together to form a composite stack.

Example 15 is the antenna of example 14 that may optionally include that the upper stack and the lower stack are bonded to the antenna element layer with adhesives.

Example 16 is the antenna of example 15 that may optionally include at least one adhesive layer between layers of the upper stack, lower stack or between the antenna element layer and one or both of the upper and lower stacks that includes one or more holes.

Example 17 is the antenna of example 14 that may optionally include that the upper stack and the lower stack are bonded to the antenna element layer using thermal bonding, thermal welding, dispense epoxies, sonic welding, or chemical bonding.

Example 18 is the antenna of example 14 that may optionally include one or more planar top and bottom load integrated dielectrics included and the composite structure is molded together as one planar structure.

Example 19 is the antenna of example 14 that may optionally include that the antenna element layer comprises a flexible material.

Example 20 is the antenna of example 14 that may optionally include that the upper stack further comprises a radome bonded to the dielectric, such that the dielectric is between the radome and the one or more impedance matching layers.

Example 21 is the antenna of example 20 that may optionally include that the radome layer comprises a multi-layer composite consisting of dielectric skins and low dielectric layers.

Example 22 is the antenna of example 14 that may optionally include that the dimensions and material properties of the one or more layers in the upper stack and the dimensions and material properties of the one or more layers in the lower stack reduce stress on the antenna element layer.

Example 23 is the antenna of example 14 that may optionally include that the lower stack comprises: a lower dielectric made of a material at least partially transparent to RF radiation; an upper dielectric made of a material at least partially transparent to RF radiation; a conductive layer sandwiched between the lower dielectric and the upper dielectric; and an electrically conductive layer formed on the side of the lower dielectric opposite where the lower dielectric is in contact with the electrically conductive layer.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. An antenna assembly comprising:
an antenna element layer having an upper side and a lower side;
a first set of one or more layers forming an upper stack bonded to the upper side of the antenna element layer and being are at least partially transparent to radio frequency (RF) radiation; and
a second set of one or more layers forming a lower stack bonded to the lower side of the antenna element layer,
the antenna element layer, upper stack and lower stack being bonded together to form a composite stack.

2. The antenna assembly of claim 1 wherein the upper stack comprises:
one or more impedance matching layers; and
a dielectric bonded to the one or more impedance matching layers.

3. The antenna assembly of claim 2 wherein the upper stack further comprises a radome bonded to the dielectric, such that the dielectric is between the radome and the one or more impedance matching layers.

4. The antenna assembly of claim 3 wherein the radome layer comprises a multi-layer composite consisting of dielectric skins and low dielectric layers.

5. The antenna assembly of claim 1 wherein the upper stack and the lower stack are bonded to the antenna element layer with adhesives.

6. The antenna assembly of claim 5 further comprises at least one adhesive layer between layers of the upper stack, lower stack or between the antenna element layer and one or both of the upper and lower stacks that includes one or more holes.

7. The antenna assembly of claim 1 wherein the upper stack and the lower stack are bonded to the antenna element layer using thermal bonding, thermal welding, dispense epoxies, sonic welding, or chemical bonding.

8. The antenna assembly of claim 1 further comprising one or more planar top and bottom load integrated dielectrics included and the composite structure is molded together as one planar structure.

9. The antenna assembly of claim 1 wherein the antenna element layer comprises a flexible material.

10. The antenna assembly of claim 1 wherein the dimensions and material properties of the one or more layers in the upper stack and the dimensions and material properties of the one or more layers in the lower stack reduce stress on the antenna element layer.

11. The antenna assembly of claim 1 wherein the lower stack comprises:
a lower dielectric made of a material at least partially transparent to RF radiation;
an upper dielectric made of a material at least partially transparent to RF radiation;
a conductive layer sandwiched between the lower dielectric and the upper dielectric; and
an electrically conductive layer formed on the side of the lower dielectric opposite where the lower dielectric is in contact with the electrically conductive layer.

12. The antenna assembly of claim 11, further comprising a structure positioned along the perimeter of the lower stack to direct RF radiation from the lower dielectric into the upper dielectric.

13. The antenna assembly of claim 1 wherein a neutral axis of the antenna assembly substantially coincides with the antenna element layer.

14. An antenna comprising:
a housing;
an antenna assembly positioned within the housing, the antenna assembly comprising:
an antenna element layer having an upper side and a lower side;
a first set of one or more layers forming an upper stack bonded to the upper side of the antenna element layer and being are at least partially transparent to radio frequency (RF) radiation, wherein the upper stack comprises
one or more impedance matching layers, and
a dielectric bonded to the one or more impedance matching layers;
a second set of one or more layers forming a lower stack bonded to the lower side of the antenna element layer,
the antenna element layer, upper stack and lower stack being bonded together to form a composite stack.

15. The antenna of claim 14 wherein the upper stack and the lower stack are bonded to the antenna element layer with adhesives.

16. The antenna of claim 15 further comprises at least one adhesive layer between layers of the upper stack, lower stack or between the antenna element layer and one or both of the upper and lower stacks that includes one or more holes.

17. The antenna of claim 14 wherein the upper stack and the lower stack are bonded to the antenna element layer using thermal bonding, thermal welding, dispense epoxies, sonic welding, or chemical bonding.

18. The antenna of claim 14 further comprising one or more planar top and bottom load integrated dielectrics included and the composite structure is molded together as one planar structure.

19. The antenna of claim 14 wherein the antenna element layer comprises a flexible material.

20. The antenna of claim 14 wherein the upper stack further comprises a radome bonded to the dielectric, such that the dielectric is between the radome and the one or more impedance matching layers.

21. The antenna of claim 20 wherein the radome layer comprises a multi-layer composite consisting of dielectric skins and low dielectric layers.

22. The antenna of claim 14 wherein the dimensions and material properties of the one or more layers in the upper stack and the dimensions and material properties of the one or more layers in the lower stack reduce stress on the antenna element layer.

23. The antenna of claim 14 wherein the lower stack comprises:
a lower dielectric made of a material at least partially transparent to RF radiation;
an upper dielectric made of a material at least partially transparent to RF radiation;
a conductive layer sandwiched between the lower dielectric and the upper dielectric; and
an electrically conductive layer formed on the side of the lower dielectric opposite where the lower dielectric is in contact with the electrically conductive layer.
